(19) United States
(12) Patent Application Publication
(10) Pub. No.: US 2012/0279305 A1
(43) Pub. Date: Nov. 8, 2012

(54) VIBRATION TEST APPARATUS

(75) Inventor: Jesper Boesen Nielsen, Esbjerg Ø (DK)

(73) Assignee: Vibrationmaster Technology Center s.á.r.l., Luxembourg (LU)

(21) Appl. No.: 13/518,606

(22) PCT Filed: Dec. 21, 2010
(86) PCT No.: PCT/DK10/50354

§ 371 Date: Jul. 31, 2012

(30) Foreign Application Priority Data
Dec. 23, 2009 (DK) PA 2009 01373

(51) Int. Cl. G01M 7/02

(52) U.S. Cl. 73/577

(57) ABSTRACT

The invention concerns a vibration test apparatus for testing various fastening elements, in particular bolt/nut connections, where a fastening element is fixed in the vibration test apparatus and subjected to lateral oscillating or vibrating actions via a carriage which is movably connected to a connecting rod, where the connecting rod is connected with a stroke regulator, where the eccentricity of the stroke regulator is adjustable during operation via a regulating mechanism. The new feature of the vibration test apparatus according to the invention is that the eccentricity of the stroke regulator via a regulating mechanism is stepless and arranged internally of a stroke regulator and at least includes a slide, where the slide is displaceable in relation to a connecting rod bearing via a control rod.

### BACKGROUND OF THE INVENTION

1. Field of the Invention

The invention concerns a vibration test apparatus for testing various fastening elements, in particular bolt/nut connections, where a fastening element is fixed in the vibration test apparatus and subjected to lateral oscillating or vibrating actions via a carriage which is movably connected to a connecting rod, where the connecting rod is connected with a stroke regulator, where the eccentricity of the stroke regulator is adjustable during operation via a regulating mechanism.

2. Description of Related Art

DIN 65151 describes a test method where a bolt-nut connection is subjected to vibrations. The test equipment according to DIN 65151 is constructed in such a way that the bolt-nut assembly is subjected to lateral oscillating movements.

These lateral movements are produced by a crank via a flexible connection moving a top part back and forth in relation to a fixed bottom part. The bolt-nut connection is bolted together around the top and bottom parts. In order to reduce friction and power consumption, a number of cylindric rollers are disposed between the movable top part and the fixed bottom part.

The test method is also called Junker's Test. The purpose of the test is to examine how a bolt-nut assembly behaves under such lateral vibrating action, as changes in the clamping force of the bolt is continuously detected via an annular weighing cell.

It is known to operate with different eccentricities of the crank, which typically are in the range 0.3-1 mm but may be down from 0 mm and up to 4 mm or more. The frequency of the oscillating movements is typically in the range 10-50 Hz, and the length of the test period may vary between a few seconds, e.g. 5 seconds, and several hours.

When a bolt-nut connection is exposed to such lateral vibration actions, typically it will occur that the nut at some time or another will come loose, and a marked drop in the clamping force measured in the bolt-nut connection is seen.

In this connection it is to be noted that the test method not only finds application to testing of bolt-nut connections as it may also be used for testing other fastening elements, such as e.g. rivets, clips etc.

JP 11-108817 indicates a machine which can be used for such tests. However, it is a somewhat primitive machine where the eccentricity is adjusted by displacing an inclining and rotating shaft relative to a connecting rod. By such a solution, the eccentricity may be adjusted when standing still as well as during operation of the machine, but it is a relatively open and thereby vulnerable design where several elements are to be displaced, thus implying a risk of play and thereby wear. Such a machine has to be highly capable of withstanding wear since it is a machine used for testing and approving other components. Therefore, it is essential for such machines that the movable parts are protected and that they are adapted in a way in which they are subjected to minimal movements and a minimum of wear. In the machine known from JP 11-108817 there is a reason for improvements with regard to the mentioned problems.

### SUMMARY OF THE INVENTION

It is the object of the invention to indicate a new and improved vibration test apparatus for testing products in the above category where adjustment of eccentricity can be performed during operation and with great accuracy. The vibration test apparatus may advantageously be a so-called stationary Junker test machine which is adapted particularly for use in connection with tests according to DIN 65151.

As indicated above, the invention concerns a vibration test apparatus for testing various fastening elements. The new feature of the vibration test apparatus according to the invention is that the eccentricity of the stroke regulator via a regulating mechanism is stepless and arranged internally of a stroke regulator and at least includes a slide, where the slide is displaceable in relation to a connecting rod bearing via a control rod.

By the present invention it is achieved that the eccentricity of the stroke regulator, corresponding to the eccentricity of a crank mechanism and thereby the amplitude of the oscillating parts, may be adjusted steplessly during operation by running pre-programmed test runs on a computer associated with the test machine and provided with software intended for testing according to DIN 65151. Alternatively, a user may easily and without using tools set the desired amplitude via the computer interface or possibly manually on the regulating mechanism itself.

According to the present invention, it is thus not necessary to interrupt the test for adjusting the amplitude, which provides the advantage that one may easily screen the assembly concerned for many different combinations of amplitude and frequency. This gives a very thorough examination of how and under which circumstances bolt/nut assemblies or other assemblies are shaken loose under the action of vibrations.

In a preferred embodiment of a vibration test apparatus according to the invention, the regulating mechanism may include an actuator which via a control rod are connected to the slide, whereby the slide and thereby the eccentricity of the connecting rod are adjusted. The actuator may preferably be an electric actuator, where the actuator is connected with control means by which a signal determines the position of the control rod and thereby the axial position of the slide as well, which is equivalent to the eccentricity. It is thus possible to control and regulate the eccentricity on a vibration test apparatus according to the invention via control means which may be electronic or, for that matter, mechanical.

In yet a preferred variant of a vibration test apparatus according to the invention, the vibration test apparatus may be driven by an electric motor where the motor either has a fixed or a variable rotational speed. Hereby is achieved yet a possibility of varying the parameters applied in connection with performing the actual tests.

The present invention may find application in laboratories in technical universities and used by firms making bolts, nuts, lock washers and similar, or in connection with testing other types of fastening means as mentioned above, where it is important or desirable to prove that the products are thoroughly tested for actions of vibration.

The invention is described in the following with reference to the drawing, wherein:

### BRIEF DESCRIPTION OF THE DRAWINGS

FIG. 1 shows a stationary Junker test machine according to the present invention partly in section, as seen from the side.

FIG. 2 shows a stationary Junker test machine according to the present invention partly in section, as seen from above and down.

FIG. 3 shows the regulating device in the stationary Junker test machine which enables stepless adjusting of the amplitude during operation, partly in section.

### DETAILED DESCRIPTION OF THE INVENTION

In the explanation of the Figures, identical or corresponding elements will be provided with the same designations in different Figures. Therefore, no explanation of all details will be given in connection with each single Figure/embodiment.

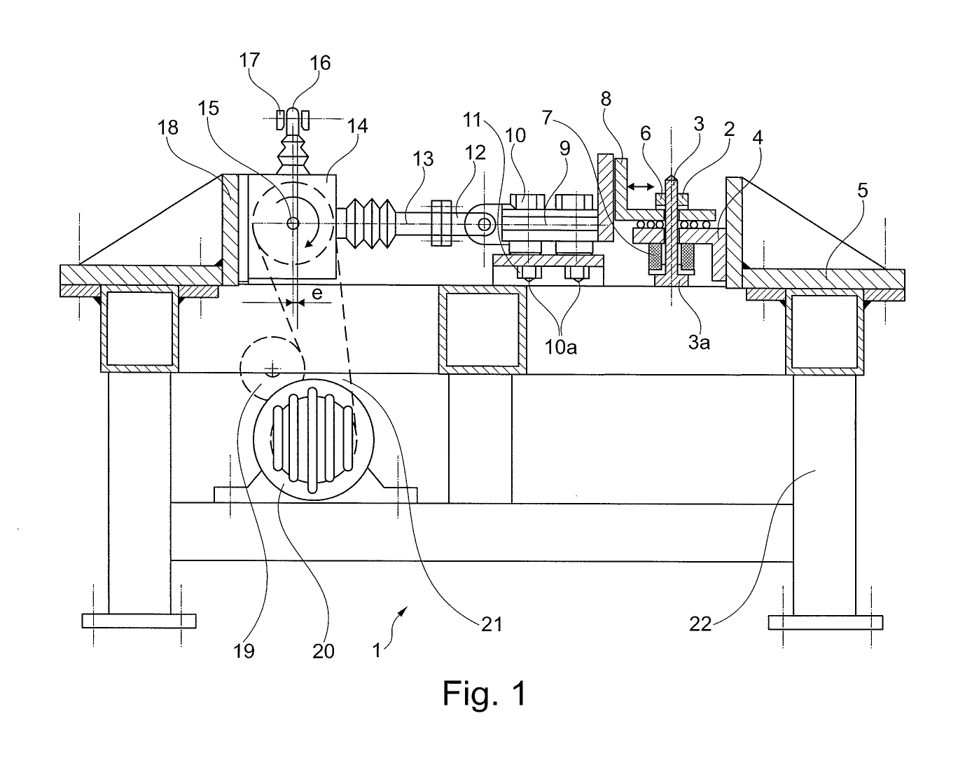

On FIG. 1 appears a vibration test apparatus 1 where a nut 2 and a corresponding bolt 3 are mounted bolted together between a lower flange 8 and an upper flange 8. Between the lower flange 4 and the bolt head 3a, an annular weighing cell 7 is mounted for transforming the clamping force prevailing at any time between the bolt head 3a and the lower flange 8 into an electric signal. Between the lower flange 4 and the upper flange 8 a number of cylindric holes 6 are provided such that the upper flange 8 can be moved laterally relative to the lower flange 4, which is retained by a support holder 5 that is adjustably fastened to the frame 22 itself by means of a number of oblong holes.

The upper flange 8 is mounted on a laterally displaceable carriage 9. The carriage 9 is guided by four profiled guide rollers 10 that each are clamped on the frame 22 by a bolt 10a and a nut 11. The guide rollers 10 are mounted rotatable on and around the said bolt 10a, the threaded end of which has an eccentricity in relation to the axis of the guide rollers. Hereby it is ensured that the carriage 9 can be adjusted in such a way that no play exists between the guide rollers 10 and the carriage 9 so that only lateral and oscillating movements are possible.

The carriage 9 is coupled movably to a connecting rod head 12 which is permanently bolted to a connecting rod 13 directly connected with a stroke regulator 14. The stroke regulator 14 is designed in such a way that when the shaft 15 is brought to rotate, the connecting rod 13 will have greater or lesser eccentricity, depending on the position of the control rod 16.

The position of the control rod is determined by an electric actuator 17 which is controlled by a computer associated with the test machine. The stroke regulator 14 is bolted directed onto the support holder 18 which is adjustably coupled to the frame 22 itself through elongated holes. The shaft 15 is brought to rotate through the belt drive 21 which is driven by an electric motor 20 that may have a fixed or a variable rotational speed. By the tensioning roller 19 it is ensured that the belt drive 21 has an appropriate belt tension.

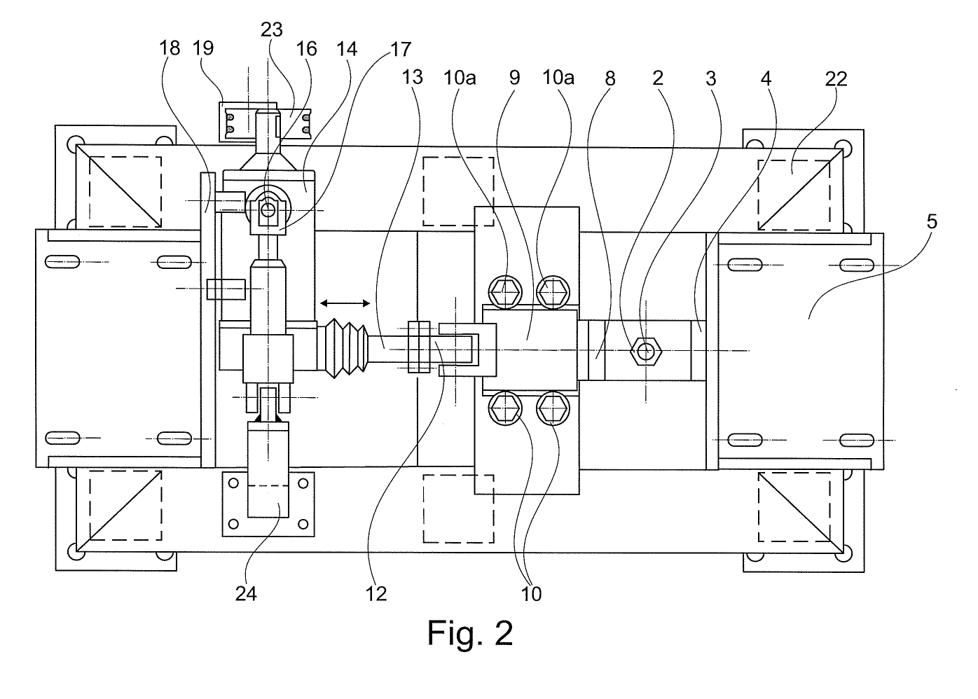

FIG. 2 shows a vibration test apparatus 1 according to the present invention, as seen from above and down. A nut 2 screwed on a bolt 3 is subjected to oscillating lateral movements in that the upper flange 8 is displaced in relation to the frame 22. The upper flange 8 is mounted on a carriage 9 which is guided by four symmetrically disposed guide rollers 10 which, as mentioned above and shown in FIG. 1, are fastened to the frame 22 via a bolt 10a, the threaded end of which having an eccentricity relative to the axis of the guide rollers.

As indicated, the carriage 9 is movably coupled to a connecting rod head 12 which is bolted to the connecting rod 13. The connecting rod 13 is directly connected with the stroke length regulator 14. The stroke length regulator 14 is regulated by a control rod 16 which is connected to an electric actuator 17. When the stroke regulator 14 is brought to rotate by means of the pulley 23 mounted on the shaft 15 of the stroke regulator, the desired amplitude of the carriage 9 and thereby of the upper flange 8 may be adjusted during operation.

The stroke regulator 14 is bolted onto the support holder 18 which is adjustably fastened to the frame 22 through elongated holes. In order to ensure that the belt 21 does not slip on the pulley 23, there is mounted a tensioning roller 19 in connection with the belt drive 21. The electric actuator 17 is fastened to the frame itself 22 by means of a bracket 24.

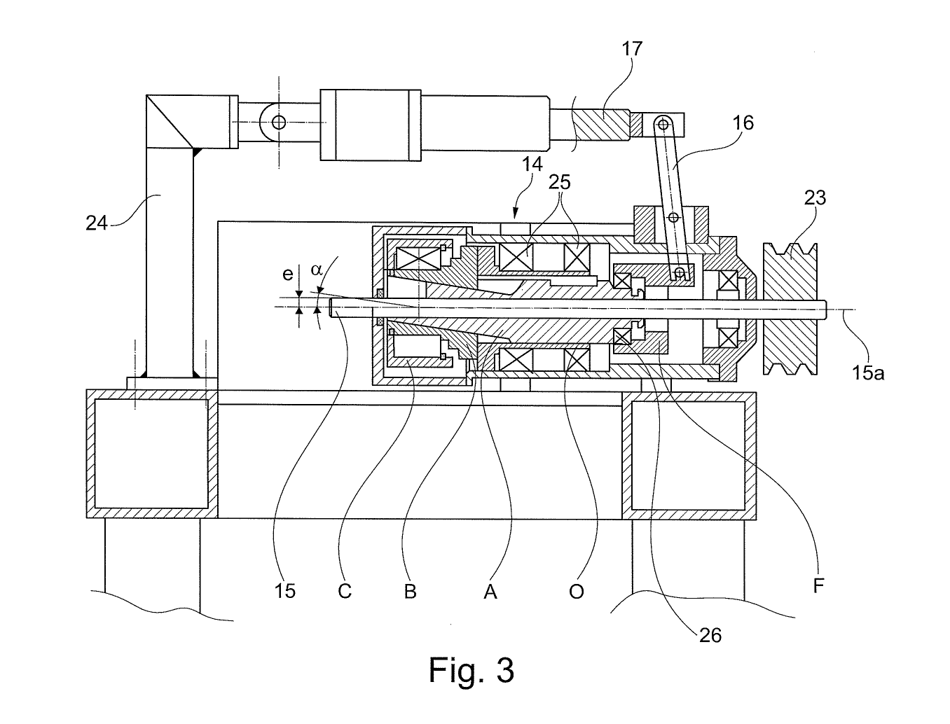

FIG. 3 shows the stroke regulator 14 in connection with the present invention and the actuator 17 which is here shown partially in section and enlarged. The stroke regulator 14 is constructed in the way that it consists of a slide A which is cylindric and provided outermost with an angularly oblique turning with the angle α relative to the centre line 15a of the slide and the shaft. The slide A and the shaft 15 are guided by the bushing D which is mounted rotatably in the housing of the stroke regulator itself by means of two ball bearings 25. The slide A is thus displaceable in the longitudinal direction of the bushing D, and between the slide A and the bushing D there are not shown guide means by which it is ensured that that the bushing D as well as the slide A are rotated under the action of the pulley 23.

In the shown variant, the angle α is selected so low as 5° but may, however, vary between 5° and 15°.

The connecting rod bearing B is coupled together with the bushing D through a dovetail guide allowing the connecting rod bearing B to be displaced in parallel with the direction of the dovetail guide, which in the shown variant of a Junker test machine corresponds to perpendicular to the centre line 15a of the shaft 15.

As the oblique turning of the slide A fits into the inclined boring in the connecting rod bearing B, a displacement of the slide A in axial direction will cause the connecting rod bearing B and thereby also the connecting rod ring C to have greater or lesser eccentricity e, as displacement of the slide A causes a movement of the connecting rod bearing B in a direction perpendicular to the shaft 15.

Displacement of the slide A co-rotating with the shaft 15 is effected steplessly during operation by moving the control rod 16 by means of the actuator 17. The control rod 16 is rotatably engaged with the stator F which then through a release bearing 26 moves the slide A in axial direction 15a. Hence, this results in that the connecting rod ring C to which the connecting rod 13 is secured is provided an eccentricity e in the range 0-2.5 mm. The shaft 15 is brought to rotate with fixed or variable rotational speed through a belt drive 21 which is mounted on the pulley 23. The actuator 17 is secured to the frame 22 by the bracket 24.

What is claimed is:

1. A vibration test apparatus for testing various fastening elements, in particular bolt/nut connections, where a fastening element is fixed in the vibration test apparatus and subjected to lateral oscillating or vibrating actions via a carriage which is movably connected to a connecting rod, where the connecting rod is connected with a stroke regulator, where the eccentricity of the stroke regulator is adjustable during operation via a regulating mechanism, wherein the regulating mechanism is stepless and arranged internally of the stroke regulator and at least includes a slide, where the slide is displaceable in relation to a connecting rod bearing via a control rod.

2. A vibration test apparatus according to claim 1, wherein the regulating mechanism includes an actuator which via an control rod is connected with the slide, whereby the slide and thereby the eccentricity of the connecting rod are adjusted, that the actuator preferably is an electric actuator, where the actuator is connected with control means by which a signal determines the position of the control rod and thereby the axial position of the slide as well, which is equivalent to the eccentricity.

3. A vibration test apparatus according to claim 1, wherein the vibration test apparatus is driven by an electric motor, where the motor has a fixed or variable rotational speed.
